(19) United States
(12) Patent Application Publication
(10) Pub. No.: US 2008/0190107 A1
(43) Pub. Date: Aug. 14, 2008

(54) Startup Control Apparatus of Internal Combustion Engine and Control Method Thereof

(75) Inventor: Makoto Ogiso, Shizuoka-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/912,058

(22) PCT Filed: Oct. 4, 2006
(86) PCT No.: PCT/IB06/02761

§ 371 Date: Oct. 19, 2007

(30) Foreign Application Priority Data
Oct. 5, 2005 (JP) 2005-292256

(51) Int. Cl. F02D 23/00; F01N 3/18; F02B 33/44; F01L 1/34

(52) U.S. Cl. 60/602; 60/284; 123/90.15; 60/605.2

(57) ABSTRACT

A startup control apparatus of an internal combustion engine including a supercharger having a turbine driven by exhaust gas from the internal combustion engine, a variable nozzle mechanism provided in the supercharger and regulating the flow rate of exhaust gas to the turbine, and an exhaust gas control catalyst arranged in an exhaust passage on the downstream side, with respect to the direction of exhaust gas flow, of the turbine. A controller selectively performs, during a cold start, control to increase the amount of combustion gas in a cylinder of the internal combustion engine by reducing the sectional area of a nozzle passage of the variable nozzle mechanism and increasing back pressure, and controls to deliver exhaust gas to the exhaust gas control catalyst by increasing the sectional area of the nozzle passage of the variable nozzle mechanism.

### BACKGROUND OF THE INVENTION

1. Field of the Invention

The invention relates to a startup control apparatus of an internal combustion engine which includes a variable nozzle mechanism that regulates the flow rate of exhaust gas to a turbine of a supercharger of the internal combustion engine, as well as to a startup control method for that internal combustion engine.

2. Description of the Related Art

Technology is known which increases boost pressure in the low engine speed range where the exhaust flow rate is small by reducing the sectional area of a nozzle passage of a variable nozzle mechanism that regulates the flow rate of exhaust gas to a turbine of a supercharger, and increases boost pressure in the high engine speed region where the flow rate of exhaust gas is large by increasing the nozzle passage section of the variable nozzle mechanism.

Japanese Patent Application Publication No. JP-A-2001-227395, for example, proposes technology which uses this variable nozzle mechanism to help warm up the cylinders in an internal combustion engine by reducing the sectional area of the nozzle passage of the variable nozzle mechanism for a set period of time during a cold start.

This technology that warms up the cylinders of an internal combustion engine, however, fails to take warming up of an exhaust gas control catalyst during a cold start into account. Thus it is desirable to better promote warming up of the entire internal combustion engine also taking into account warming up of the exhaust gas control catalyst.

### SUMMARY OF THE INVENTION

This invention thus provides technology that more appropriately performs startup control of an internal combustion engine.

Thus one aspect of the invention employs the following structure. That is, a startup control apparatus of an internal combustion engine including a supercharger having a turbine that is driven by exhaust gas from the internal combustion engine, a variable nozzle mechanism which is provided in the supercharger and regulates the flow rate of exhaust gas to the turbine, and an exhaust gas control catalyst arranged in an exhaust gas passage on the downstream side, with respect to the direction of exhaust gas flow, of the turbine, is provided with nozzle controlling means for selectively performing, during a cold start, control to increase the amount of combustion gas in a cylinder of the internal combustion engine by reducing the sectional area of a nozzle passage of the variable nozzle mechanism and increasing back pressure, and control to deliver combustion gas to the exhaust gas control catalyst by increasing the sectional area of the nozzle passage of the variable nozzle mechanism.

According to this aspect of the invention, during a cold start control is performed which increases the amount of combustion gas in the cylinder of the internal combustion engine by reducing the sectional area of the nozzle passage of the variable nozzle mechanism and increasing back pressure. As a result, the cylinder of the internal combustion engine is rapidly warmed up by the heat of the combustion gas in it, while exhaust gas is heated to a high temperature by the combustion gas being combusted again. Also during a cold start, control is also performed which delivers combustion gas to the exhaust gas control catalyst by increasing the sectional area of the nozzle passage of the variable nozzle mechanism. As a result, the amount of combustion gas that reaches the exhaust gas control catalyst increases and the exhaust gas control catalyst is rapidly heated by heat from that combustion gas. Moreover, these controls are performed selectively.

That is, reducing the sectional area of the nozzle passage of the variable nozzle mechanism is the opposite of increasing the sectional area of the nozzle passage of the variable nozzle mechanism. However, by selectively performing both controls during a cold start, it is possible to warm up both the cylinder of the internal combustion engine and the exhaust gas control catalyst, and thereby promote warming up of the entire internal combustion engine such that startup control of the internal combustion engine can be more appropriately performed.

Incidentally, it is possible to warm up the entire internal combustion engine from the upstream side in the direction of the intake and exhaust flow. That is, it is possible to first warm up the cylinder of the internal combustion engine as much as possible by performing control to increase the amount of combustion gas in the cylinder of the internal combustion engine by reducing the sectional area of the nozzle passage of the variable nozzle mechanism and increasing the back pressure, and then warm up the exhaust gas control catalyst by performing control to deliver combustion gas to the exhaust gas control catalyst by increasing the sectional area of the nozzle passage of the variable nozzle mechanism. However, when warming up the exhaust gas control catalyst using control to deliver combustion gas to the exhaust gas control catalyst by increasing the sectional area of the nozzle passage, the temperature of the catalyst bed rises slowly over time. As a result, it takes time for the temperature of the exhaust gas control catalyst to rise to a target temperature. Therefore, the entire internal combustion engine is unable to be warmed up rapidly when it is warmed up from the upstream side in the direction of the intake and exhaust flow in this way.

According to this foregoing aspect of the invention, however, the control to warm up the exhaust gas control catalyst, i.e., the control to deliver combustion gas to the exhaust gas control catalyst by increasing the sectional area of the nozzle passage of the variable nozzle mechanism, is performed intermittently until the exhaust gas control catalyst is completely warmed up. That is, the control to warm up the exhaust gas control catalyst is performed between intervals of the control to warm up the cylinder of the internal combustion engine, i.e., the control to increase the amount of combustion gas in the cylinder of the internal combustion engine by reducing the sectional area of the nozzle passage of the variable nozzle mechanism and increasing the back pressure. As a result, the entire internal combustion engine is able to warm up rapidly with the temperature of the exhaust gas control catalyst rapidly rising to the target temperature and the cylinder of the internal combustion engine warming up quickly by repeatedly using the region in which there is a significant rise in the catalyst bed temperature when the exhaust gas control catalyst is warmed up.

The nozzle controlling means may perform the controls selectively according to at least one of an engine load, operating state, or temperature.

Accordingly, both the cylinder of the internal combustion engine and the exhaust gas control catalyst are able to be optimally warmed up in a balanced manner according to the engine load, operating state, or temperature.

The nozzle controlling means may perform the control to increase the amount of combustion gas in the cylinder of the internal combustion engine by reducing the sectional area of the nozzle passage of the variable nozzle mechanism and increasing the back pressure immediately after a cold start.

Accordingly, immediately after a cold start the cylinder of the internal combustion engine can be rapidly warmed up, while combustion gas to be delivered to the exhaust gas control catalyst can be rapidly heated so that the temperature of the exhaust gas rises to a high temperature. When the exhaust gas control catalyst is then warmed up, the heat from the combustion gas which has been heated to a high temperature in the cylinder rapidly warms up the exhaust gas control catalyst.

The nozzle controlling means may perform the control to deliver combustion gas to the exhaust gas control catalyst by increasing the sectional area of the nozzle passage of the variable nozzle mechanism while the exhaust gas control catalyst is warming up.

Accordingly, exhaust gas resistance is reduced so the amount of combustion gas delivered to the exhaust gas control catalyst increases. The heat from the combustion gas that reaches the exhaust gas control catalyst rapidly warms up the exhaust gas control catalyst.

The nozzle controlling means may alternate between performing the control to increase the amount of combustion gas in the cylinder of the internal combustion engine by reducing the sectional area of the nozzle passage of the variable nozzle mechanism and increasing the back pressure, and performing the control to deliver combustion gas to the exhaust gas control catalyst by increasing the sectional area of the nozzle passage of the variable nozzle mechanism.

Accordingly, the temperature of the combustion gas is raised to a high temperature by the control to increase the amount of combustion gas in the cylinder of the internal combustion engine by reducing the sectional area of the nozzle passage of the variable nozzle mechanism and increasing the back pressure. Meanwhile, the amount of combustion gas discharged from the internal combustion engine is increased by the control to deliver combustion gas to the exhaust gas control catalyst by increasing the sectional area of the nozzle passage of the variable nozzle mechanism. Performing these controls alternately thus enables the amount of combustion gas discharged from the internal combustion engine to be increased while keeping that combustion gas at a high temperature, as well as the exhaust gas control catalyst to be warmed up rapidly by the heat from the combustion gas that reaches the exhaust gas control catalyst.

The startup control apparatus may also include a variable valve timing mechanism that changes a valve timing of at least one of an intake valve and an exhaust valve, and valve timing controlling means for increasing the amount of valve overlap or advancing the closing timing of the exhaust valve when performing the control to increase the amount of combustion gas in the cylinder of the internal combustion engine by reducing the sectional area of the nozzle passage of the variable nozzle mechanism and increasing the back pressure, and decreasing the amount of valve overlap or setting the valve timing of at least one of the intake valve and the exhaust valve to a valve timing that improves scavenging efficiency when performing the control to deliver combustion gas to the exhaust gas control catalyst by increasing the sectional area of the nozzle passage of the variable nozzle mechanism.

Accordingly, the amount of combustion gas in the cylinder of the internal combustion engine is increased by increasing the amount of valve overlap or advancing the closing timing of the exhaust valve when performing the control to increase the amount of combustion gas in the cylinder of the internal combustion engine by reducing the sectional area of the nozzle passage of the variable nozzle mechanism and increasing the back pressure. Therefore, the cylinder of the internal combustion engine is rapidly warmed up by the heat of the combustion gas in it. Further, the amount of combustion gas delivered to the exhaust gas control catalyst is increased by reducing the amount of valve overlap or setting the valve timing of at least one of the intake valve and the exhaust valve to a timing that improves scavenging efficiency when performing the control to deliver combustion gas to the exhaust gas control catalyst by increasing the sectional area of the nozzle passage of the variable nozzle mechanism. As a result, the exhaust gas control catalyst is rapidly warmed up by the heat from the combustion gas that reaches it.

The startup control apparatus may also include an EGR passage that circulates combustion gas from an exhaust passage of the internal combustion engine to an intake passage of the internal combustion engine, an EGR valve that regulates the flow rate of combustion gas flowing through the EGR passage, and EGR valve controlling means for increasing the flow rate of combustion gas flowing through the EGR passage by increasing the opening amount of the EGR valve when performing the control to increase the amount of combustion gas in the cylinder of the internal combustion engine by reducing the sectional area of the nozzle passage of the variable nozzle mechanism and increasing the back pressure, and reducing the flow rate of combustion gas flowing through the EGR passage by decreasing the opening amount of the EGR valve when performing the control to deliver combustion gas to the exhaust gas control catalyst by increasing the sectional area of the nozzle passage of the variable nozzle mechanism.

Accordingly, the amount of combustion gas in the cylinder of the internal combustion engine is increased by increasing the flow rate of combustion gas flowing through the EGR passage when performing the control to increase the amount of combustion gas in the cylinder of the internal combustion engine by reducing the sectional area of the nozzle passage of the variable nozzle mechanism and increasing the back pressure. Therefore, the cylinder of the internal combustion engine is rapidly warmed up by the heat of the combustion gas in it. Further, the amount of combustion gas delivered to the exhaust gas control catalyst is increased by reducing the flow rate of the combustion gas flowing through the EGR passage when performing the control to deliver combustion gas to the exhaust gas control catalyst by increasing the sectional area of the nozzle passage of the variable nozzle mechanism. As a result, the exhaust gas control catalyst is rapidly warmed up by the heat from the combustion gas that reaches it.

This aspect of the invention makes it possible to more appropriately perform startup control of an internal combustion engine.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a block diagram schematically showing an internal combustion engine, and intake/exhaust systems thereof, to which a startup control apparatus according to one example embodiment of the invention is applied;

FIG. 2 is a graph showing a change in bed temperature of an exhaust gas control catalyst that occurs from switching controls according to the example embodiment;

FIG. 3 is a flowchart illustrating a control routine for switching controls according to the example embodiment;

FIG. 4 is a flowchart illustrating a control routine for switching controls according to a modified example of the example embodiment;

FIG. 5 is a flowchart illustrating a control routine for switching controls according to another modified example of the example embodiment; and

FIG. 6 is a flowchart illustrating a control routine for switching controls according to still another modified example of the example embodiment.

### DETAILED DESCRIPTION OF THE PREFERRED EMBODIMENTS

In the following description and the accompanying drawings, the present invention will be described in more detail in terms of exemplary embodiments.

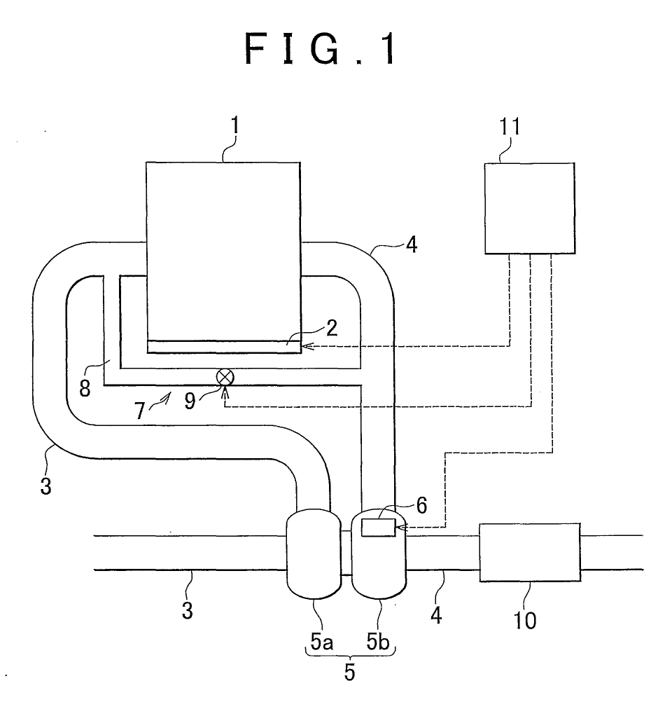

FIG. 1 is a block diagram schematically showing an internal combustion engine, and intake/exhaust systems thereof, to which a startup control apparatus according to one example embodiment of the invention is applied.

The internal combustion engine 1 shown in FIG. 1 is an in-line four cylinder water-cooled four-cycle diesel engine.

A valve driving mechanism 2 drives intake valves and exhaust valves of each cylinder of the internal combustion engine 1 open and closed. This valve driving mechanism 2 is able to variably control the opening and closing timings and valve lift amounts (i.e., valve opening amounts) of the intake and exhaust valves.

Any one of various mechanisms which utilize various operating principles may be used for the valve driving mechanism 2. For example, the valve driving mechanism 2 may be a cam mechanism which is operatively linked to the rotation of a crankshaft and drives the intake and exhaust valves selectively using cams having a plurality of shapes or drives the valves in combination with a mechanism that corrects the operation of the cams. The valve driving mechanism 2 may also be a mechanism that applies electromagnetic force to the intake and exhaust valves in the direction in which they move up and down. Employing a mechanism which applies this electromagnetic force obviates the need to operatively link the operation of the intake and exhaust valves to the rotation of crankshaft, which increases the degree of freedom with respect to control of the operating speed and operating range.

Meanwhile, an intake passage 3 and an exhaust passage 4 are connected to the internal combustion engine 1. A compressor 5a of a turbocharger (i.e., a supercharger) 5 is arranged midway in the exhaust passage 3 while a turbine 5b of the turbocharger 5 is arranged midway in the exhaust passage 4. The turbine 5b is driven by exhaust gas flowing through the exhaust passage 4. The compressor 5a rotates together with the driven turbine 5b, supercharging intake air flowing through the intake passage 3 as it does so.

The turbocharger 5 has a variable nozzle 6 provided surrounding the entire periphery of the turbine 5b in a turbine chamber that houses the turbine 5b. Rotating the variable nozzle 6 changes the sectional area of a nozzle passage formed in the middle of the variable nozzle 6. When the variable nozzle 6 is rotated such that the sectional area of the nozzle passage is made smaller, the boost pressure in the low speed range of the internal combustion engine 1 in which the exhaust gas flow rate is small increases. On the other hand, when the variable nozzle 6 is rotated such that the sectional area of the nozzle passage is made larger, the boost pressure in the high speed range of the internal combustion engine 1 in which the exhaust gas flow rate is large increases. Thus the variable nozzle mechanism is formed of the variable nozzle 6 which changes the sectional area of the nozzle passage in this way and an actuator that drives the variable nozzle 6.

The internal combustion engine 1 is also provided with an EGR apparatus 7. This EGR apparatus 7 includes an EGR passage 8 which provides communication between the exhaust passage 4 and the intake passage 3, and an EGR valve 9 which is provided in the EGR passage 8 and regulates the amount of EGR gas (i.e., combustion gas) that flows through the EGR passage 8. The EGR apparatus 7 introduces some of the exhaust gas (i.e., combustion gas) in the exhaust passage 4 into the intake passage 3 via the EGR passage 8 by increasing the opening amount of the EGR valve 9.

Also, an exhaust gas control catalyst 10 for purifying exhaust gas discharged from the cylinders of the internal combustion engine 1 is provided in a portion of the exhaust passage 4 downstream of the turbine 5b. In this exhaust gas control catalyst 10, a NOx storage-reduction catalyst is carried on a filter that traps PM from smoke and the like that is discharged from the internal combustion engine 1.

An electronic control unit (ECU) 11 for controlling the internal combustion engine 1 is also provided in the internal combustion engine 1 of the foregoing structure. This ECU 11 is a control computer that includes a CPU, ROM, RAM, backup RAM and the like.

Various sensors such as a coolant temperature sensor and the like are electrically connected to this ECU 11, and the ECU 11 receives output signals from these sensors.

Other components, such as the valve driving mechanism 2, the variable nozzle 6, the EGR valve 9, a fuel injection valve of the internal combustion engine 1, and a reducing agent addition valve for adding fuel into the exhaust passage 4 are also electrically connected to, and driven by, the ECU 11.

When the internal combustion engine 1 is started cold, i.e., during a cold start, the internal combustion engine 1 must be warmed up, and it is preferable that this be done quickly. Therefore, this example embodiment aims to shorten the time that it takes to warm up the entire internal combustion engine, including warming up the cylinders of the internal combustion engine 1 and the exhaust gas control catalyst 10.

Thus in this example embodiment, during a cold start, two controls are selectively performed. One of these controls increases the amount of exhaust gas flowing into the cylinders of the internal combustion engine 1 by reducing the sectional area of the nozzle passage of the variable nozzle 6 and increasing the back pressure in the exhaust passage 4 upstream of the turbine 5b. The other of these controls delivers exhaust gas to the exhaust gas control catalyst 10 by reducing, to the greatest extent possible, the exhaust gas resistance of the turbine 5b by increasing sectional area of the nozzle passage of the variable nozzle 6. The ECU 11 which selectively controls the rotation of the variable nozzle 6 in this way serves as one example of the nozzle controlling means of the invention.

That is, increasing the back pressure in the exhaust passage 4 upstream of the turbine 5b by reducing the sectional area of the nozzle passage of the variable nozzle 6 during a cold start returns combustion gas that was discharged from the cylinders of the internal combustion engine 1 to the cylinders as well as retains the combustion gas in the cylinders without discharging it to increase the amount of combustion gas in the cylinders of the internal combustion engine 1. As a result, the heat from that combustion gas rapidly warms the cylinders of the internal combustion engine 1 and the combustion gas is heated to a high temperature by being combusted again.

Also, combustion gas is delivered to the exhaust gas control catalyst 10 with the exhaust gas resistance from the variable nozzle 6 of the turbine 5b reduced as much as possible by increasing the sectional area of the nozzle passage of the variable nozzle 6 during a cold start. As a result, the amount of exhaust gas (i.e., combustion gas) flowing to the exhaust gas control catalyst 10 increases and the exhaust gas control catalyst 10 warms up rapidly from the heat of the exhaust gas (i.e., combustion gas) that reaches it.

Control to reduce the sectional area of the nozzle passage of the variable nozzle 6 and control to increase the sectional area of the nozzle passage of the variable nozzle 6 are selectively performed during a cold start. The control that reduces the sectional area of the nozzle passage of the variable nozzle 6 is the opposite of the control that increases the sectional area of the nozzle passage of the variable nozzle 6. Selectively performing these controls during a cold start, however, promotes warming up of the entire internal combustion engine, i.e., it warms up both the cylinders of the internal combustion engine 1 and the exhaust gas control catalyst 10, such that startup control of the internal combustion engine 1 can be more appropriately performed.

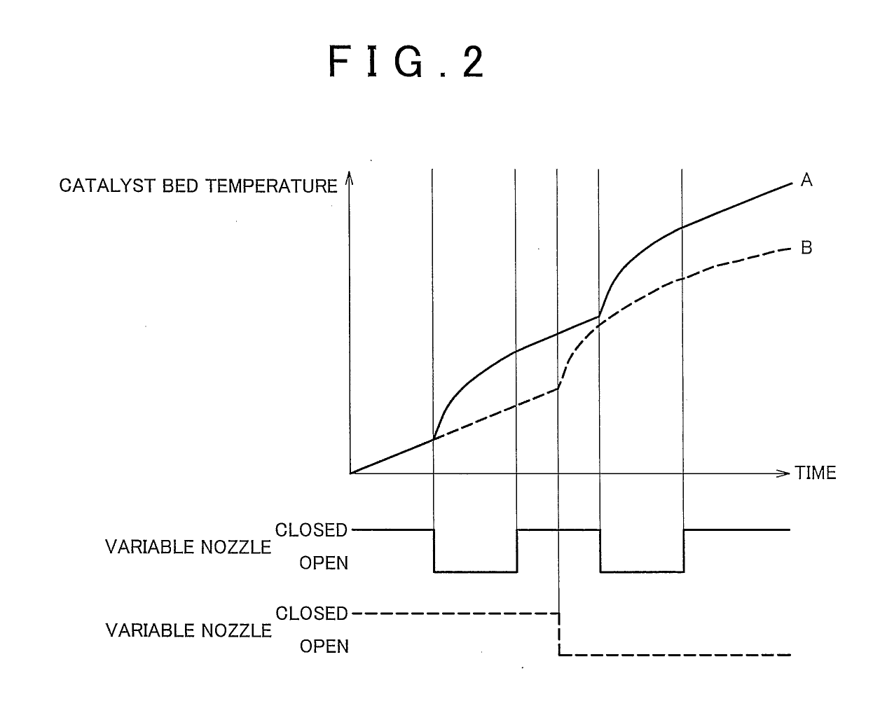

As shown by broken line B in FIG. 2, it is also possible to warm up the internal combustion engine from the upstream side in the direction of the intake and exhaust flow by first performing control to reduce the sectional area of the nozzle passage of the variable nozzle so that the cylinders of the internal combustion engine warm up completely, and then performing control to increase the sectional area of the nozzle passage to warm up the exhaust gas control catalyst. However, when warming up the exhaust gas control catalyst using control to increase the sectional area of the nozzle passage as shown by the broken line B, the temperature of the catalyst bed rises slowly over time so it takes time for the temperature of the exhaust gas control catalyst to rise to a target temperature. Therefore, when the internal combustion engine is warmed up from the upstream side in the direction of the intake and exhaust flow, it takes time for the entire internal combustion engine including the exhaust gas control catalyst to warm up, i.e., the entire internal combustion engine is not able to be warmed up rapidly.

According to this example embodiment, on the other hand, as shown by solid line A in FIG. 2 which illustrates one example, the control to warm up the exhaust gas control catalyst 10, i.e., the control to increase the sectional area of the nozzle passage of the variable nozzle mechanism, is performed intermittently until the exhaust gas control catalyst 10 is completely warmed up. That is, that control is performed between intervals of warming up the cylinders of the internal combustion engine 1 using the control to decrease the sectional area of the nozzle passage. Therefore, the region in which there is a significant rise in the catalyst bed temperature when the exhaust gas control catalyst 10 is warmed up by the control to increase the sectional area of the nozzle passage can be used repeatedly. As a result, the entire internal combustion engine 1 is able to warm up rapidly with the temperature of the exhaust gas control catalyst 10 quickly rising to the target temperature and the cylinders of the internal combustion engine 1 warming up quickly.

Control to reduce the sectional area of the nozzle passage and control to increase to the sectional area of the nozzle passage are selectively performed according to the exhaust gas temperature that is input to the ECU 11. As a result, the warming up of the cylinders of the internal combustion engine 1 is able to be optimally balanced with the warming up of the exhaust gas control catalyst 10 according to the temperature of the exhaust gas.

Alternatively, the controls may also be selectively performed according to the engine load or operating state. In this case as well, the cylinders of the internal combustion engine 1 as well as the exhaust gas control catalyst 10 can be optimally warmed up in a balanced manner.

Also, control to reduce the sectional area of the nozzle passage may be performed immediately after a cold start. As a result, the cylinders of the internal combustion engine 1 can be rapidly warmed up immediately after a cold start. In addition, combustion gas delivered to the exhaust gas control catalyst 10 is also quickly heated to a high temperature. When the exhaust gas control catalyst 10 is then warmed up, it is warmed up rapidly by the combustion gas that was heated to a high temperature in the cylinders.

Moreover, control to increase the sectional area of the nozzle passage is performed while warming up the exhaust gas control catalyst 10. As a result, the exhaust gas resistance is reduced so the amount of combustion gas delivered to the exhaust gas control catalyst 10 increases. Accordingly, the exhaust gas control catalyst 10 is rapidly warmed up by the heat from the combustion gas that reaches it.

Also, as shown by the solid line A in FIG. 2, the control to reduce the sectional area of the nozzle passage and the control to increase the sectional area of the nozzle passage are performed alternately. As a result, temperature of the combustion gas rises from the control to reduce the sectional area of the nozzle passage and the amount of combustion gas increases from the control to increase the sectional area of the nozzle passage. By alternating back and forth between these two controls, the amount combustion gas discharged from the internal combustion engine 1 is increased while being maintained at a high temperature, thus enabling the exhaust gas control catalyst 10 to be warmed up rapidly.

Here in this example embodiment, the cylinders of the internal combustion engine 1 and the exhaust gas control catalyst 10 are warmed up with the valve driving mechanism 2 changing the opening and closing timings of the intake and exhaust valves as the variable nozzle 6 changes the sectional area of the nozzle passage. The ECU 11 that controls this kind of valve driving mechanism 2 serves as valve timing controlling means in this example embodiment.

That is, when the sectional area of the nozzle passage of the variable nozzle 6 is reduced, the amount of valve overlap i.e., the period of time during which both the intake valve and the exhaust valve are open, is increased or the closing timing of the exhaust valve is advanced. As a result, if the amount of valve overlap is increased while the back pressure in the exhaust passage 4 upstream of the turbine 5b is high, combustion gas from inside the cylinders is delivered to the intake passage 3 and that combustion gas is then introduced back into the cylinders on the intake stroke. Also, if the closing timing of the exhaust valve is advanced, some of the combustion gas remains in the cylinder without flowing out to the exhaust passage 4. As a result, the amount of combustion gas in the cylinders of the internal combustion engine increases and those cylinders are rapidly warmed up by the heat of that combustion gas.

Also, when the sectional area of the nozzle passage of the variable nozzle 6 is increased, the amount of valve overlap, i.e., the period of time during which both the intake valve and the exhaust valve are open, is decreased or the valve timing of at least one of the intake valve and the exhaust valve is set to a timing that improves the scavenging efficiency of the exhaust gas in the cylinders. As a result, the exhaust gas resistance from the variable nozzle 6 of the turbine 5b is reduced as much as possible, while the amount of valve overlap is reduced. Accordingly, combustion gas is sent downstream in the exhaust passage 4. Also, setting the valve timing of one of the intake valve and the exhaust valve to a timing at which the most combustion gas is discharged from the cylinder, i.e., a timing that improves scavenging efficiency, results in combustion gas being sent downstream in the exhaust passage 4. Therefore, more combustion gas is delivered to the exhaust gas control catalyst 10 and the exhaust gas control catalyst 10 is rapidly warmed up by the heat of that combustion gas.

Also, here in this example embodiment, the cylinders of the internal combustion engine 1 and the exhaust gas control catalyst 10 are warmed up while regulating the amount of combustion gas that flows through the EGR valve 9 of the EGR apparatus 7 as the sectional area of the nozzle passage is changed by the variable nozzle 6. The ECU 11 that controls the EGR valve 9 of the EGR apparatus 7 in this way serves as EGR valve controlling means in this example embodiment.

That is, when the sectional area of the nozzle passage of the variable nozzle 6 is reduced, the opening amount of the EGR valve 9 is increased to increase the flow rate of combustion gas flowing through the EGR passage 8. As a result, the flow rate of the combustion gas flowing through the EGR passage 8 increases when the back pressure in the exhaust passage 4 upstream of the turbine 5b is high. Accordingly, much of the combustion gas that was discharged from the cylinders to the exhaust passage 4 is returned to the intake passage 3 and then introduced into the cylinders again on the intake stroke. As a result, the amount of combustion gas in the cylinders of the internal combustion engine 1 increases, and the cylinders of the internal combustion engine 1 are warmed up rapidly by the heat of that combustion gas.

Also, when the sectional area of the nozzle passage of the variable nozzle 6 is increased, the opening amount of the EGR valve 9 is reduced to decrease the flow rate of combustion gas flowing through the EGR passage 8. As a result, the exhaust gas resistance from the variable nozzle 6 of the turbine 5b is reduced as much as possible, while the flow rate of the combustion gas flowing through the EGR passage 8 decreases. Accordingly, the combustion gas is inhibited from returning to the intake passage 3 via the EGR passage 8 and therefore flows downstream in the exhaust passage 4. Thus, more combustion gas flows to the exhaust gas control catalyst 10 which rapidly warms up from the heat of that combustion gas.

In this way, in this example embodiment, changing the sectional area of the nozzle passage of the variable nozzle 6, changing the opening and closing timings of the intake and exhaust valves by the valve driving mechanism 2, and regulating the amount of combustion gas that flows through the EGR valve 9 of the EGR apparatus 7 together constitute, in this example embodiment, control for increasing the amount of combustion gas in the cylinders of the internal combustion engine 1 and control for delivering combustion gas to the exhaust gas control catalyst 10, during a cold start.

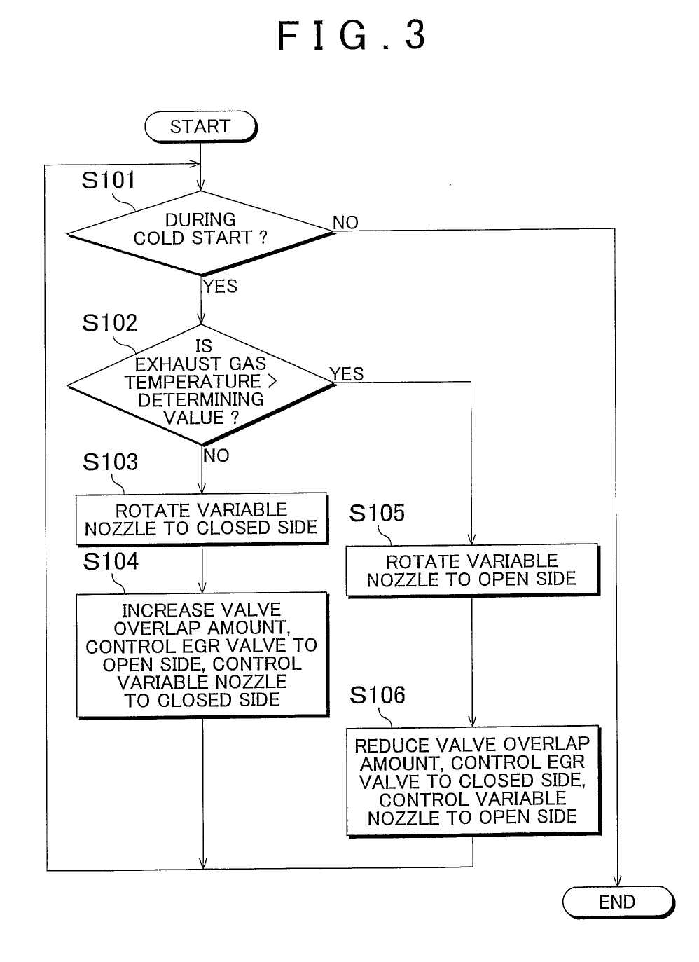

More specifically, in this example embodiment, the ECU 11 controls the variable nozzle 6, the valve driving mechanism 2, and the EGR valve 9 according to the routine in the flowchart of FIG. 3. This routine is one which is executed by the ECU 11 at predetermined intervals of time or by interruption upon receiving a pulse signal from a crank position sensor or the like. Hereinafter the routine will be described with reference to the flowchart shown in FIG. 3.

This control routine is stored in ROM of the ECU 11 in advance. First in step S101, the ECU 11 determines whether a cold start is being performed. The ECU 11 determines that a cold start is being performed when, for example, the coolant temperature detected by a coolant temperature sensor is equal to or less than a certain temperature, an estimated exhaust gas temperature calculated by the ECU 11 is equal to or less than a certain temperature, or an estimated temperature of the exhaust gas control catalyst 10 calculated by the ECU 11 is equal to or less than a certain temperature. In this example embodiment, if it is determined that a cold start is being performed, the process proceeds on to step S102. If, on the other hand, it is determined that a cold start is not being performed, then the routine ends.

In step S102 the ECU 11 determines whether the estimated exhaust gas temperature calculated by the ECU 11 is higher than a determining value (i.e., whether “exhaust gas temperature>determining value”). The determining value in this case is a value that changes according to the estimated temperature of the exhaust gas control catalyst calculated by the ECU 11. If it is determined that the exhaust gas temperature is not higher than the determining value (i.e., “exhaust gas temperature>determining value” is not satisfied), then the process proceeds on to step S103. If, on the other hand, the exhaust gas temperature is higher than the determining value (i.e., “exhaust gas temperature>determining value” is satisfied), then the process proceeds on to step S105.

In step S103, the ECU 11 rotates the variable nozzle 6 to the closed side to reduce the sectional area of the nozzle passage. As a result, during a cold start, the sectional area of the nozzle passage of the variable nozzle 6 is reduced, which increases the back pressure in the exhaust passage 4 upstream of the turbine 5b. Accordingly, combustion gas that had been discharged from the cylinders of the internal combustion engine 1 returns to the cylinders and combustion gas within the cylinders is retained there without being discharged, thus increasing the amount of combustion gas in cylinders of the internal combustion engine 1. As a result, the heat from the combustion gas within the cylinders of the internal combustion engine 1 rapidly warms the cylinders, while the temperature of the exhaust gas is raised by the combustion gas being combusted again.

Next in step S104 which follows step S103, the ECU 11 increases the amount of valve overlap, i.e., the period of time during which both the intake valve and the exhaust valve are open, or advances the closing timing of the exhaust valve. Alternatively or in addition, the ECU 11 increases the opening amount of the EGR valve 9 to increase the flow rate of the combustion gas that flows through the EGR passage 8. As a result, the cylinders of the internal combustion engine 1 warm up rapidly. The process then returns to step S101.

On the other hand, in step S105, the ECU 11 rotates the variable nozzle 6 to the open side to increase the sectional area of the nozzle passage. Accordingly, during a cold start, the sectional area of the nozzle passage of the variable nozzle 6 increases which reduces the exhaust gas resistance from the variable nozzle 6 of the turbine 5b as much as possible so combustion gas flows to the exhaust gas control catalyst 10. As a result, the amount of exhaust gas (i.e., combustion gas) that flows to the exhaust gas control catalyst 10 increases. The heat from the exhaust gas (i.e., combustion gas) that reaches the exhaust gas control catalyst 10 rapidly warms it up.

Next in step S106 which follows step S105, the ECU 11 reduces the amount of valve overlap, i.e., the period of time during which both the intake valve and the exhaust valve are open, or sets the timing of at least one of the intake valve and the exhaust valve to a timing when the most combustion gas is discharged from the cylinders, i.e., a timing that improves scavenging efficiency. Alternatively or in addition, the ECU 11 reduces the flow rate of the combustion gas that flows through the EGR passage 8 by reducing the opening amount of the EGR valve 9. As a result, the exhaust gas control catalyst 10 warms up quickly. The process then returns to step S101.

Accordingly, in the flowchart shown in FIG. 3, control is switched depending on the exhaust gas temperature between the control in steps S103 and S104 to warm up the cylinders of the internal combustion engine 1, and the control in steps S105 and S106 to warm up the exhaust gas control catalyst 10. Then when the engine is no longer cold, the routine ends.

In this way, by selectively performing the control in steps S103 and S104 and the control in steps S105 and S106 during a cold start, both the cylinders of the internal combustion engine 1 as well as the exhaust gas control catalyst 10 are warmed up, thereby promoting the warming up of the entire internal combustion engine so that startup control of the internal combustion engine 1 can be more appropriately performed.

In this example embodiment, the control performed switches between the control in steps S103 and S104 and the control in steps S105 and S106 depending on the exhaust gas temperature. In modified examples of the example embodiment of the invention, however, the control may switch depending on other factors such as the amount of time passed after a cold start, the operating state of the engine, the engine load, or the like.

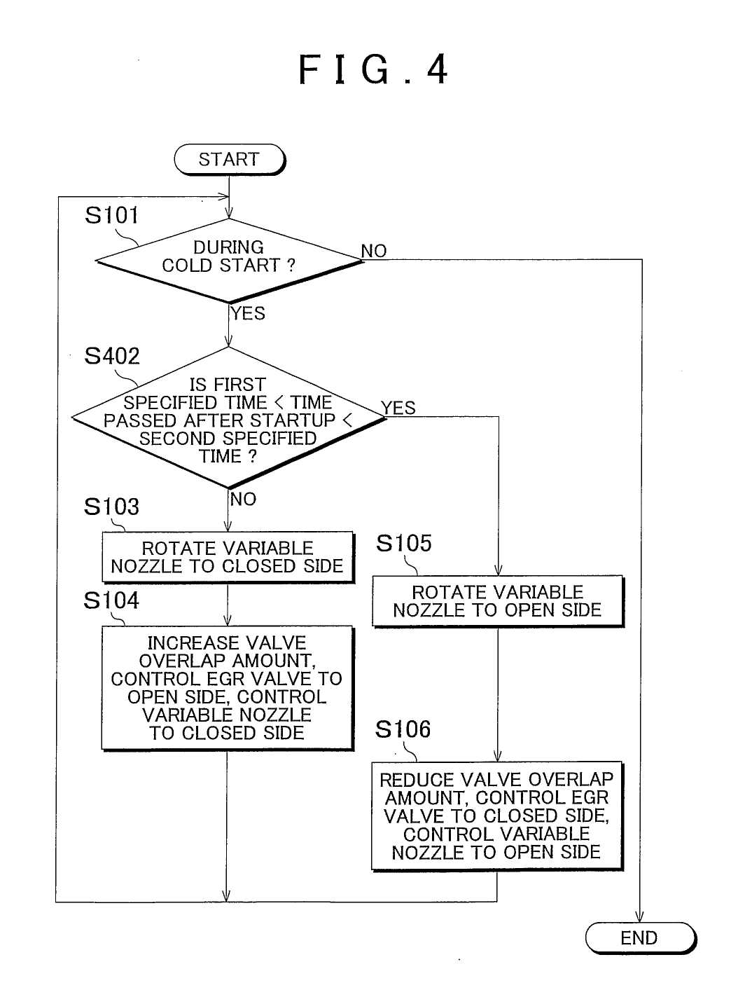

For example, as shown in the flowchart of FIG. 4, the control performed may be switched between the control in steps S103 and S104 and the control in steps S105 and S106 according to the result of a comparison in step S402 of a first specified time, the time passed after startup, and a second specified time. That is, the control in steps S105 and S106 is performed if in step S402 the time passed after startup is between the first specified time and the second specified time (i.e., if “first specified time<time passed after startup<second specified time” is satisfied). In any other case (i.e., if “first specified time<time passed after startup<second specified time” is not satisfied), the control in steps S103 and S104 is performed. The first specified time and the second specified time change (i.e., increase) according to the number of times the routine has been repeated.

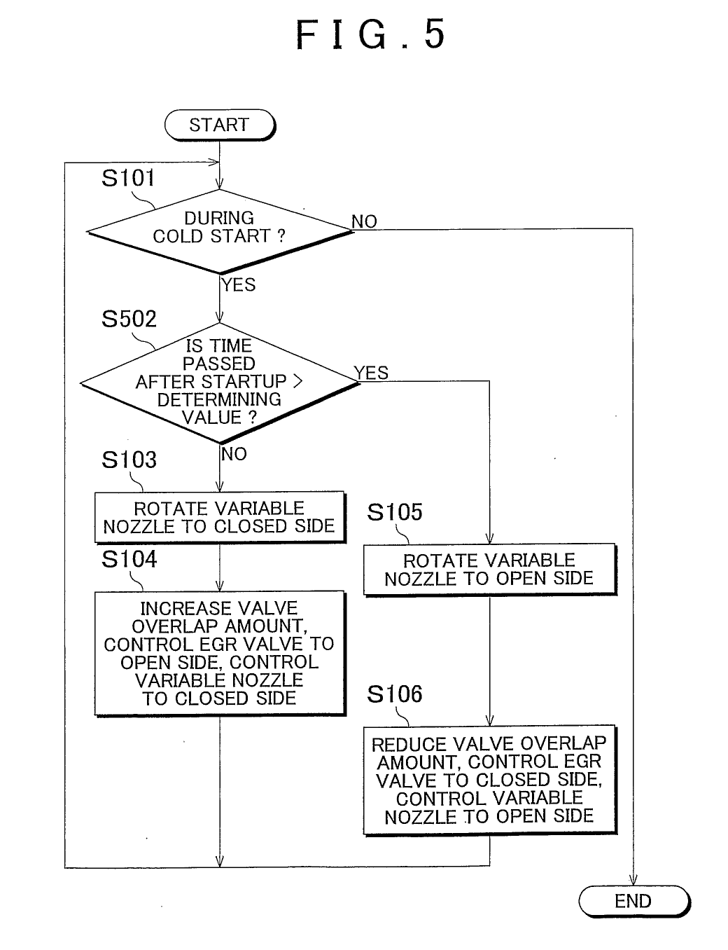

Also, as shown in the flowchart of FIG. 5, the control may switch between the control in steps S103 and S104 and the control in steps S105 and S106 according to the result of a comparison in step S502 of the time passed after startup and a determining value. That is, the control in steps S105 and S106 is performed if in step S502 the time passed after startup is greater than the determining value (i.e., if “time passed after startup>determining value” is satisfied), and the control in steps S103 and S104 is performed if in step S502 the time passed after startup is less than the determining value (i.e., if “time passed after startup>determining value” is not satisfied).

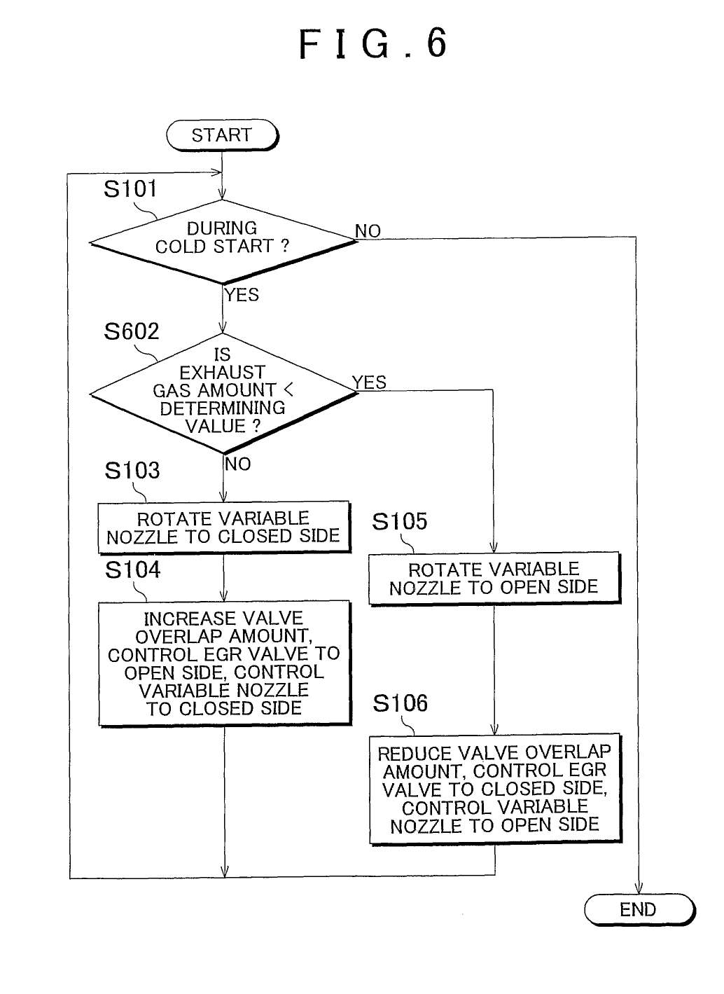

Also, as shown in the flowchart of FIG. 6, the control may switch between the control in steps S103 and S104 and the control in steps S105 and S106 according to the result of a comparison in step S602 of the exhaust gas amount that changes depending on the engine load and operating state and a determining value. That is, the control in steps S105 and S106 is performed if in step S602 the exhaust gas amount is less than the determining value (i.e., if “exhaust gas amount<determining value” is satisfied), and the control in steps S103 and S104 is performed if in step S602 the exhaust gas amount is greater than the determining value (i.e., if “exhaust gas amount<determining value” is not satisfied).

The control may also be switched based on the result of a comparison of another value, such as the exhaust gas temperature that changes depending on the engine load, and a determining value. Also, the steps S101 and S103 to S106 in the flowcharts in FIGS. 4 to 6 are the same as steps S101 and S103 to S106 in the flowchart in FIG. 3 so descriptions thereof have been omitted.

While the invention has been described with reference to exemplary embodiments thereof, it is to be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

1-25. (canceled)

26. A startup control apparatus of an internal combustion engine, comprising:
a supercharger having a turbine that is driven by exhaust gas from the internal combustion engine;
a variable nozzle mechanism which is provided in the supercharger and regulates the flow rate of exhaust gas to the turbine;
an exhaust gas control catalyst arranged in an exhaust passage on the downstream side, with respect to the direction of exhaust gas flow, of the turbine; and
a nozzle control device that selectively performs, during a cold start, control to increase the amount of combustion gas in a cylinder of the internal combustion engine by reducing the sectional area of a nozzle passage of the variable nozzle mechanism and increasing back pressure, and control to deliver combustion gas to the exhaust gas control catalyst by increasing the sectional area of the nozzle passage of the variable nozzle mechanism.

27. The startup control apparatus of an internal combustion engine according to claim 26, wherein during a cold start, the nozzle control device performs the control to deliver combustion gas to the exhaust gas control catalyst by increasing the sectional area of the nozzle passage of the variable nozzle mechanism between intervals of performing the control to increase the amount of combustion gas in the cylinder of the internal combustion engine by reducing the sectional area of the nozzle passage of the variable nozzle mechanism and increasing the back pressure.

28. The startup control apparatus of an internal combustion engine according to claim 26, wherein the nozzle control device performs the controls selectively according to at least one of an engine load, operating state, or temperature.

29. The startup control apparatus of an internal combustion engine according to claim 26, wherein the nozzle control device performs the control to increase the amount of combustion gas in the cylinder of the internal combustion engine by reducing the sectional area of the nozzle passage of the variable nozzle mechanism and increasing the back pressure immediately after a cold start.

30. The startup control apparatus of an internal combustion engine according to claim 26, wherein the nozzle control device performs the control to deliver combustion gas to the exhaust gas control catalyst by increasing the sectional area of the nozzle passage of the variable nozzle mechanism while the exhaust gas control catalyst is warming up.

31. The startup control apparatus of an internal combustion engine according to claim 26, wherein the nozzle control device alternates between performing the control to increase the amount of combustion gas in the cylinder of the internal combustion engine by reducing the sectional area of the nozzle passage of the variable nozzle mechanism and increasing the back pressure, and performing the control to deliver combustion gas to the exhaust gas control catalyst by increasing the sectional area of the nozzle passage of the variable nozzle mechanism.

32. The startup control apparatus of an internal combustion engine according to claim 28, wherein the nozzle control device performs the control to increase the sectional area of the nozzle passage of the variable nozzle mechanism when an exhaust gas temperature is higher than a determining value, and performs the control to reduce the sectional area of the nozzle passage of the variable nozzle mechanism when the exhaust gas temperature is lower than the determining value.

33. The startup control apparatus of an internal combustion engine according to claim 28, wherein the nozzle control device performs the control to increase the sectional area of the nozzle passage of the variable nozzle mechanism when a time passed after startup is between a first specified time and a second specified time that is longer than the first specified time, and performs the control to reduce the sectional area of the nozzle passage of the variable nozzle mechanism when the time passed after startup is shorter than the first specified time or longer than the second specified time.

34. The startup control apparatus of an internal combustion engine according to claim 28, wherein the nozzle control device performs the control to increase the sectional area of the nozzle passage of the variable nozzle mechanism when a time passed after startup is greater than a determining value, and performs the control to reduce the sectional area of the nozzle passage of the variable nozzle mechanism when the time passed after startup is less than the determining value.

35. The startup control apparatus of an internal combustion engine according to claim 28, wherein the nozzle control device performs the control to increase the sectional area of the nozzle passage of the variable nozzle mechanism when an exhaust gas amount is less than a determining value, and performs the control to reduce the sectional area of the nozzle passage of the variable nozzle mechanism when the exhaust gas amount is greater than the determining value.

36. The startup control apparatus of an internal combustion engine according to claim 26, further comprising:
a variable valve timing mechanism that changes a valve timing of at least one of an intake valve and an exhaust valve; and
a valve timing control device that increases an amount of valve overlap or advances closing timing of the exhaust valve when performing the control to increase the amount of combustion gas in the cylinder of the internal combustion engine by reducing the sectional area of the nozzle passage of the variable nozzle mechanism and increasing the back pressure, and decreases the amount of valve overlap or sets the valve timing of at least one of the intake valve and the exhaust valve to a valve timing that improves scavenging efficiency when performing the control to deliver combustion gas to the exhaust gas control catalyst by increasing the sectional area of the nozzle passage of the variable nozzle mechanism.

37. The startup control apparatus of an internal combustion engine according to claim 26, further comprising:
an EGR passage that circulates combustion gas from the exhaust passage of the internal combustion engine to an intake passage of the internal combustion engine;
an EGR valve that regulates the flow rate of combustion gas flowing through the EGR passage; and
an EGR valve control device that increases the flow rate of combustion gas flowing through the EGR passage by increasing an opening amount of the EGR valve when performing the control to increase the amount of combustion gas in the cylinder of the internal combustion engine by reducing the sectional area of the nozzle passage of the variable nozzle mechanism and increasing the back pressure, and reduces the flow rate of combustion gas flowing through the EGR passage by decreasing the opening amount of the EGR valve when performing the control to deliver combustion gas to the exhaust gas control catalyst by increasing the sectional area of the nozzle passage of the variable nozzle mechanism.

38. A startup control method for an internal combustion engine provided with a supercharger having a turbine that is driven by exhaust gas from the internal combustion engine, a variable nozzle mechanism which is provided in the supercharger and regulates the flow rate of exhaust gas to the turbine, and an exhaust gas control catalyst arranged in an exhaust passage on the downstream side, with respect to the direction of exhaust gas flow, of the turbine, the method comprising:
selectively performing, during a cold start, control to increase an amount of combustion gas in a cylinder of the internal combustion engine by reducing the sectional area of a nozzle passage of the variable nozzle mechanism and increasing back pressure, and control to deliver combustion gas to the exhaust gas control catalyst by increasing the sectional area of the nozzle passage of the variable nozzle mechanism.

39. The startup control method for an internal combustion engine according to claim 38, wherein during a cold start, the control to deliver combustion gas to the exhaust gas control catalyst by increasing the sectional area of the nozzle passage of the variable nozzle mechanism is performed between intervals of performing the control to increase the amount of combustion gas in the cylinder of the internal combustion engine by reducing the sectional area of the nozzle passage of the variable nozzle mechanism and increasing the back pressure.

40. The startup control method for an internal combustion engine according to claim 38, wherein the controls are selectively performed according to at least one of an engine load, operating state, or temperature.

41. The startup control method for an internal combustion engine according to claim 38, wherein the control to increase the amount of combustion gas in the cylinder of the internal combustion engine by reducing the sectional area of the nozzle passage of the variable nozzle mechanism and increasing the back pressure is performed immediately after a cold start.

42. The startup control method for an internal combustion engine according to claim 38, wherein the control to deliver combustion gas to the exhaust gas control catalyst by increasing the sectional area of the nozzle passage of the variable nozzle mechanism is performed while the exhaust gas control catalyst is warming up.

43. The startup control method for an internal combustion engine according to claim 38, wherein the control to increase the amount of combustion gas in the cylinder of the internal combustion engine by reducing the sectional area of the nozzle passage of the variable nozzle mechanism and increasing the back pressure, and the control to deliver combustion gas to the exhaust gas control catalyst by increasing the sectional area of the nozzle passage of the variable nozzle mechanism, are performed alternately.

44. The startup control method for an internal combustion engine according to claim 40, wherein the control to increase the sectional area of the nozzle passage of the variable nozzle mechanism is performed when an exhaust gas temperature is higher than a determining value, and the control to reduce the sectional area of the nozzle passage of the variable nozzle mechanism is performed when the exhaust gas temperature is lower than the determining value.

45. The startup control method for an internal combustion engine according to claim 40, wherein the control to increase the sectional area of the nozzle passage of the variable nozzle mechanism is performed when a time passed after startup is between a first specified time and a second specified time that is longer than the first specified time, and the control to reduce the sectional area of the nozzle passage of the variable nozzle mechanism is performed when the time passed after startup is shorter than the first specified time or longer than the second specified time.

46. The startup control method for an internal combustion engine according to claim 40, wherein the control to increase the sectional area of the nozzle passage of the variable nozzle mechanism is performed when a time passed after startup is greater than a determining value, and the control to reduce the sectional area of the nozzle passage of the variable nozzle mechanism is performed when the time passed after startup is less than the determining value.

47. The startup control method for an internal combustion engine according to claim 40, wherein the control to increase the sectional area of the nozzle passage of the variable nozzle mechanism is performed when an exhaust gas amount is less than a determining value, and the control to reduce the sectional area of the nozzle passage of the variable nozzle mechanism is performed when the exhaust gas amount is greater than the determining value.

48. The startup control method for an internal combustion engine according to claim 38, further comprising:
increasing an amount of valve overlap or advancing a closing timing of the exhaust valve when performing the control to increase the amount of combustion gas in the cylinder of the internal combustion engine by reducing the sectional area of the nozzle passage of the variable nozzle mechanism and increasing the back pressure; and
decreasing the amount of valve overlap or setting the valve timing of at least one of the intake valve and the exhaust valve to a valve timing that improves scavenging efficiency when performing the control to deliver combustion gas to the exhaust gas control catalyst by increasing the sectional area of the nozzle passage of the variable nozzle mechanism.

49. The startup control method for an internal combustion engine according to claim 38, further comprising:
increasing the flow rate of combustion gas flowing through an EGR passage that circulates combustion gas from the exhaust passage of the internal combustion engine to an intake passage of the internal combustion engine, by increasing an opening amount of an EGR valve that regulates the flow rate of combustion gas flowing through the EGR passage, when performing the control to increase the amount of combustion gas in the cylinder of the internal combustion engine by reducing the sectional area of the nozzle passage of the variable nozzle mechanism and increasing the back pressure; and
reducing the flow rate of combustion gas flowing through the EGR passage by decreasing the opening amount of the EGR valve when performing the control to deliver combustion gas to the exhaust gas control catalyst by increasing the sectional area of the nozzle passage of the variable nozzle mechanism.
